(19) United States
(12) Patent Application Publication
(10) Pub. No.: US 2015/0058734 A1
(43) Pub. Date: Feb. 26, 2015

(54) METHOD FOR AUTOMATICALLY CREATING AN INTERACTIVE SOFTWARE SIMULATION

(71) Applicant: Teddy Bruce Ward, Los Gatos, CA (US)

(72) Inventor: Teddy Bruce Ward, Los Gatos, CA (US)

(21) Appl. No.: 13/975,314

(22) Filed: Aug. 24, 2013

(51) Int. Cl. G06F 3/0484

(52) U.S. Cl. CPC G06F 3/0484
USPC 715/731

(57) ABSTRACT

A method, implemented in software, to capture user activities and the appearance of the computer screen into a plurality of screenshots and to automatically create an Interactive User Interface Simulation that can be used to demonstrate any arbitrary software system for sales, training, or other purposes, without requiring the original software system to be working or available. The Simulation includes a method for displaying and updating the appearance of the screen by monitoring user activities and responding appropriately so that the presentation closely resembles, in both appearance and behavior, the live running software system from which the Simulation was created.

### CROSS-REFERENCES TO RELATED APPLICATIONS

Not Applicable

### STATEMENT REGARDING FEDERALLY SPONSORED RESEARCH OR DEVELOPMENT

Not Applicable

### MICROFICHE APPENDIX

Not Applicable

### REFERENCE

Provisional Patent Application# 61/796,065

### BACKGROUND

1. Field of the Invention

This invention relates to the field of computer software. Specifically, it provides an automated software method that creates the data for an interactive simulation of the user interface of any arbitrary software system.

2. Description of the Related Art

The ability to create video recordings of computer screens as the user walks through various activities is a well-known capability in the software world. The videos produced by this process (often referred to as ‘screencams’) are common on many web sites and especially on video sharing sites such as http://www.youtube.com. Many commercial and non-commercial software tools have been created to provide this capability. Among the many uses for this technology are technical training and sales demonstrations (or ‘demos’) of complex software systems. In addition to the relatively simple and well-known process of creating videos, some software provides the ability to create interactive simulations that respond to user inputs and act much like actual software applications. For differentiation, it is worth noting that videos generally capture an image of the mouse pointer so that the audience can follow the recorded actions, whereas simulations use the actual mouse pointer of the presentation system as controlled in real time by the presenter. These simulations offer the appearance and behavior ('look and feel') of a live system with much greater convenience, reliability and repeatability. Also, the most robust of these simulations offer ‘branching’ or ‘multiple paths’ that allow the presenter to jump to and from and/or skip functional areas of the User Interface (UI) of the system.

Both videos and simulations are used for training, demos and other purposes because they effectively show the system of interest, but are very unlikely to fail or perform badly at inopportune moments. When presenting to an audience, however, interactive simulations are superior because they are interactive and respond to the user's actions, so it is much more obvious how the actual software applications work. Simulations that provide multiple paths are especially useful because they allow the presenter to tailor the flow of the presentation to match the needs and interests of each particular audience, rather than following a pre-recorded path (as required by a video/screencam).

Despite the fact that simulations have substantial advantages over both live applications and screencam videos when presenting to an audience, they are relatively uncommon today because current technologies for creating them require a substantial amount of work by highly-skilled technicians. This often makes them too expensive and/or time-consuming to justify. And because technology evolves rapidly, the simulations need to updated frequently, compounding the cost and complexity and further hampering widespread adoption. The present invention provides a method that automates the creation of robust, multi-path simulations and eliminates much of the complexity and effort that has traditionally been required to create them.

### SUMMARY

The present invention provides a method to create interactive software user interface (UI) simulations. Unlike current tools for creating simulations, the present invention uses the algorithms described below to create simulations automatically, without requiring the efforts of skilled technicians. The present invention can be implemented on any computing platform, including, but not limited to, computers running Microsoft Windows, computers running Apple Mac OSX, computers running Linux or Unix, handheld computers and/or phones running Apple IOS, Google Android Windows Phone. The present invention is composed of three parts which are described separately here, but may be presented to the user as either a single application or a plurality of tools / applications. These capabilities can also be segmented into a combination of localized and cloud-based services, with some or all parts running on any mix of the two. The three parts are:

1. A method for capturing the computer screen as it changes over time and simultaneously capturing user activities, specifically mouse motion and clicks. This method is subsequently referred to as the ‘Capture Process’.

2. A method for analyzing the information recorded during the Capture Process and automatically converting it into an interactive simulation of the software system's user interface (UI). This method is subsequently referred to as the ‘Abstraction Process’.

3. A method for displaying and updating the UI simulation while monitoring user activities and making the UI respond appropriately. This method is used during presentation of the simulation and is referred to as the ‘Presentation Process’.

### BRIEF DESCRIPTION OF THE DRAWINGS

FIG. 1—a flowchart of the logic used to capture the computer screen and user actions during the Capture Process

FIG. 2—list of instruction types created during the Abstraction Process and used during the Presentation Process

FIG. 3—flowchart describing the algorithm for finding Mouseover steps that proceed Click steps during the Abstraction Process

FIG. 4—pseudocode to describe the process for adding multi-path instructions during the Abstraction process

FIG. 5—flowchart describing the process for monitoring user activities and making the UI respond appropriately—the Presentation Process

### DETAILED DESCRIPTION

### Section 1

### Method of Capture

### Capture Process

A simulation is composed of a series of steps. Each step in the capture contains:
1. a screenshot
2. the mouse position on the screen in x,y coordinates
3. a Click flag—set if the mouse has been clicked since the last step
4. a timestamp in milliseconds of the time the step took place

NOTE: Possible user inputs include left-, middle-, and right-mouse clicks, and keyboard keystrokes. In the interest of simplicity, keyboard keystrokes and specifics of which mouse button is clicked have been excluded from this explanation, but the invention described herein encompasses these capabilities.

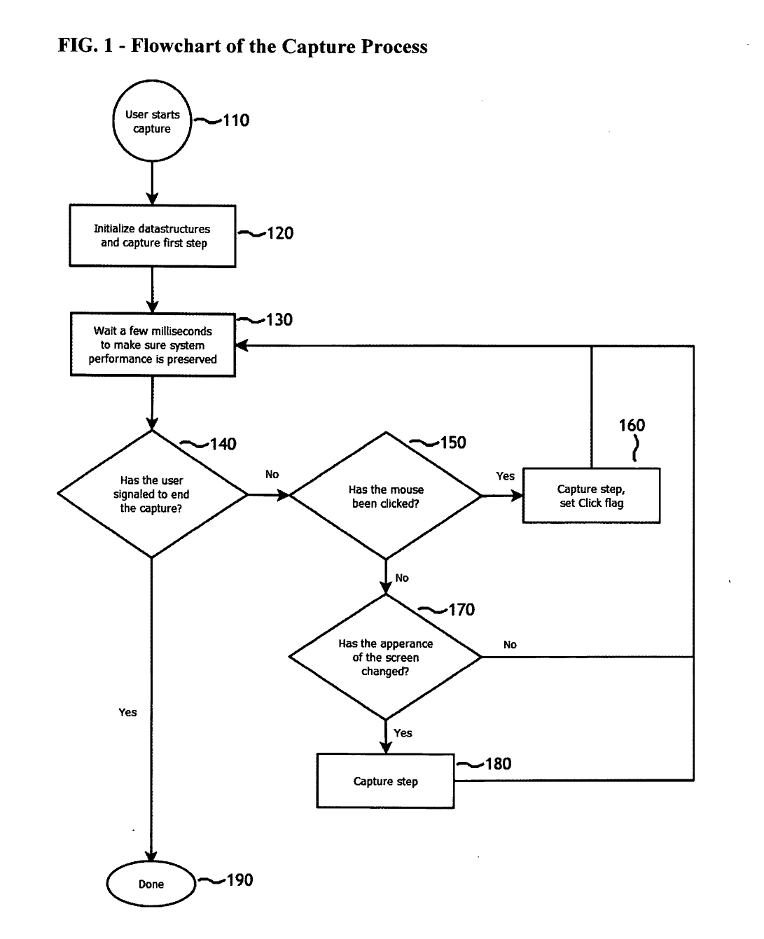

As illustrated in FIG. 1, the capture begins when the user requests it 110 to do so by clicking an on-screen element, typically a UI button. Immediately after the user's request to begin, the software initializes data structures and files 120 which will hold the steps. It may also minimize or otherwise hide the UI of the capture system so that it does not interfere with the information being captured. The first step is stored and then the capture system enters a loop that executes repeatedly until the user interacts with the capture UI and requests that it stop. Within the loop, the following procedures are followed:

1. Wait a short while (a few milliseconds) 130 to maintain system performance

2. If the user has signaled an end to the capture 140, exit the loop 190

3. If the mouse has been clicked 150, capture the Step 160, set Click flag, return to # 1_{.}

4. If the appearance of the screen has changed 170, capture the Step 180 and return to # 1

5. Return to # 1

### Section 2

### Method of Analysis and Conversion

### Abstraction Process

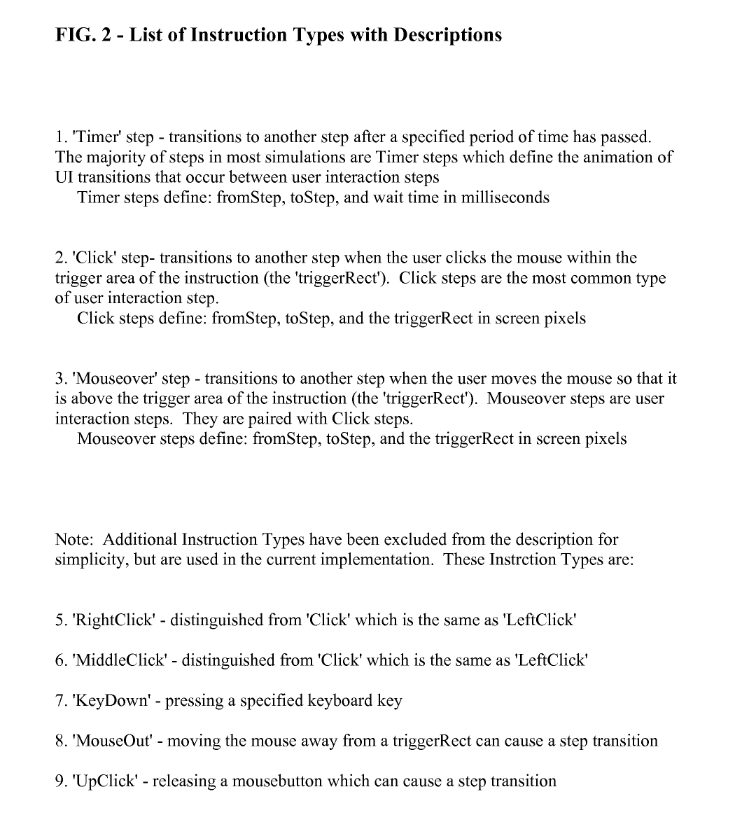

Analyzing and converting the capture into a simulation requires 3 different processes. To understand the processes, it is important to note that a simulation is composed of a series of Steps. Each Step record contains:
1. a ‘friendly name’ for the step
2. speaker note text to be optionally displayed
3. a screenshot
4. the mouse position on the screen in x,y coordinates
5. one or more Instructions. Each Instruction is one of the types listed in FIG. 2.

There are 3 main processes used to analyze and convert the capture into a simulation:

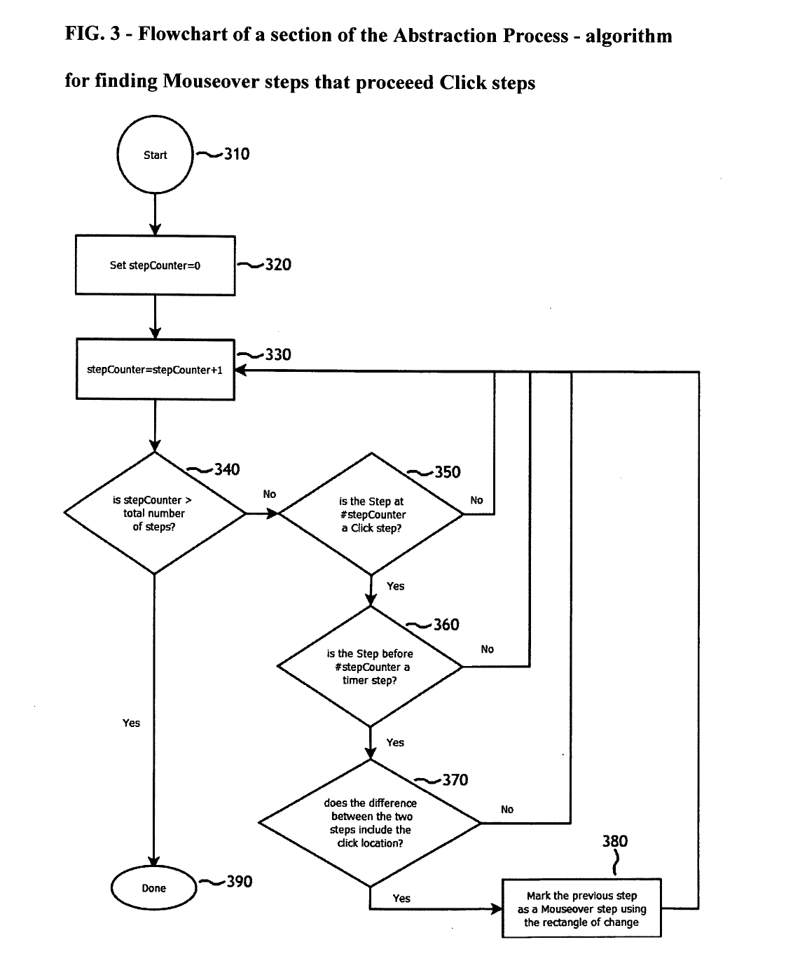

1. Find and mark Mouseover steps proceeding Click steps—To simulate UIs that change when the mouse moves, simulations have to recognize when changes in UI appearance are the result of mouse motions. A typical example is a UI Button that ‘lights up’ when the mouse hovers over it. To determine where Mouseover steps should be created (FIG. 3), we look at each Click step 350 and the step before it 360. If the step before the Click step is a Timer step and if the area of the change in screen appearance between the two steps overlaps the click location 370, this indicates that the mouse movement triggered the change in appearance and therefore, the step before the Click step is marked as a Mouseover step 380. The trigger rectangle is set to match the rectangle of the screen change between the two steps.

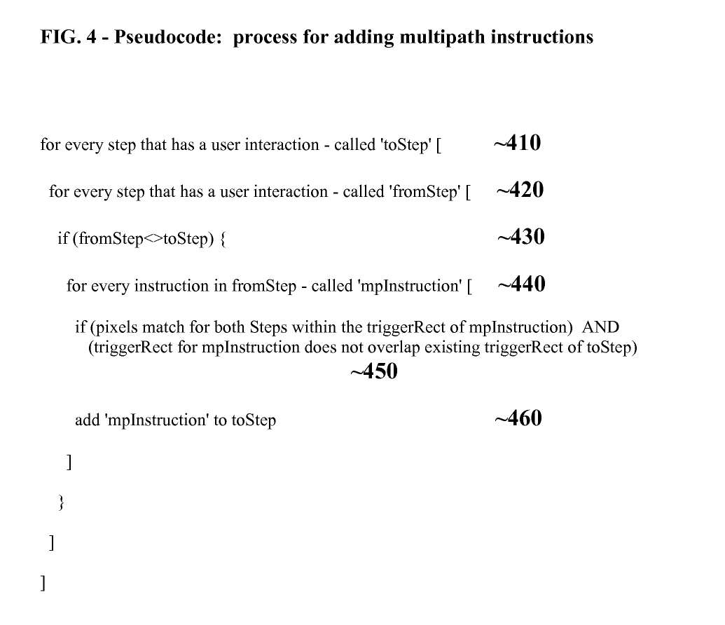

2. Add multipath instructions—FIG. 4—each step marked for user interaction (Click or Mouseover) 410 is inspected and compared to every other step 420 marked for user interaction. If the trigger area of any other step 440 is identical, and there is no trigger area already defined in the same location 450, we add the instruction to the step 460.

3. Store step information and instructions for each step. During this process, the ‘friendly name’ and ‘speaker notes’ for each step are generated. Either or both the ‘friendly name’ or ‘speaker notes’ may be changed by the user in subsequent editing. Each step also has one or more instructions as generated during the previous processes. For steps that have a targetRect that is not derived from a screen change upon mousemove, the targetRect is placed as a fixed-size rectangle centered around the location of the click.

### Section 3

### Method of UI Simulation Display and Managing User Interactions

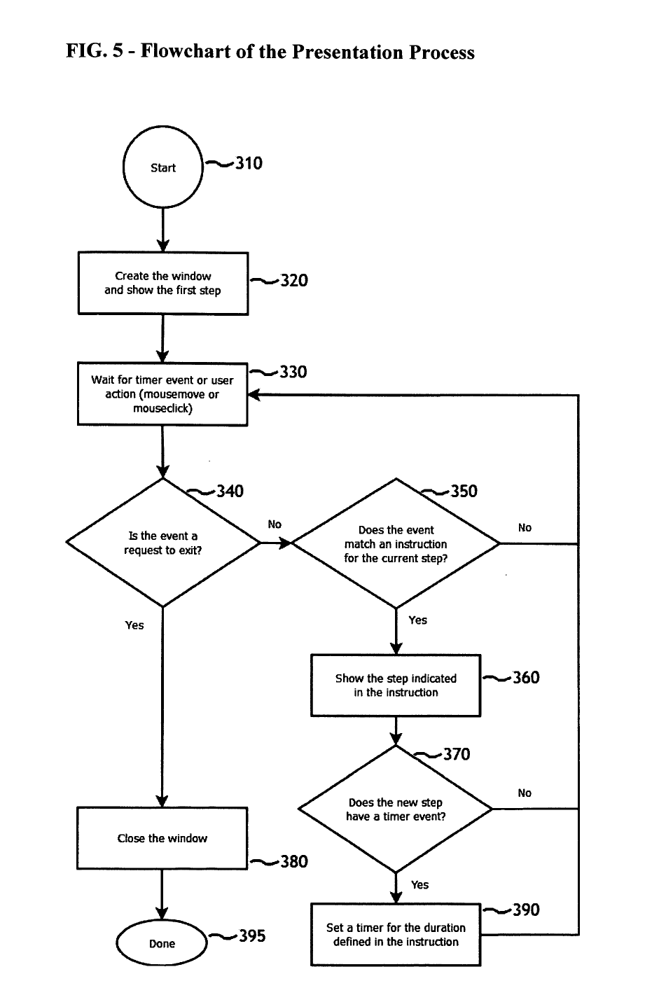

To display the UI simulation (FIG. 5.), the screenshot from the current step is displayed to the screen 320. Steps change 330 as a result of either Timer events or user actions 350. When a step is loaded 360 any Timer instructions 370 cause a background timer to start 390. When the timer fires, it triggers a transition to load the next step (which then starts the next timer if the next frame is a Timer frame). For user interaction steps (Click or Mouseover), the simulation waits for the user 330 to click or move the mouse in a particular triggerRect location 350.

While the foregoing written description of the invention enables persons of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

### FIG. 2

List of Instruction Types with Descriptions

1. ‘Timer’ step—transitions to another step after a specified period of time has passed. The majority of steps in most simulations are Timer steps which define the animation of UI transitions that occur between user interaction steps
Timer steps define: fromStep, toStep, and wait time in milliseconds

2. ‘Click’ step—transitions to another step when the user clicks the mouse within the trigger area of the instruction (the ‘triggerRect’). Click steps are the most common type of user interaction step.
Click steps define: fromStep, toStep, and the triggerRect in screen pixels

3. ‘Mouseover’ step—transitions to another step when the user moves the mouse so that it is above the trigger area of the instruction (the ‘triggerRect’). Mouseover steps are user interaction steps. They are paired with Click steps.
Mouseover steps define: fromStep, toStep, and the triggerRect in screen pixels

Note: Additional Instruction Types have been excluded from the description for simplicity, but are used in the current implementation. These Instrction Types are:

5. ‘RightClick’—distinguished from ‘Click’ which is the same as ‘LeftClick’

6. ‘MiddleClick’—distinguished from ‘Click’ which is the same as ‘LeftClick’

7. ‘KeyDown’—pressing a specified keyboard key

8. ‘MouseOut’—moving the mouse away from a triggerRect can cause a step transition

9. ‘UpClick’—releasing a mousebutton which can cause a step transition

### FIG. 4

### Pseudocode: Process For Adding Multipath Instructions

| | |
|---|---|
| for every step that has a user interaction - called 'toStep' [ | ~410 |
| for every step that has a user interaction - called 'fromStep' [ | ~420 |
| if (fromStep < >toStep) { | ~430 |
| for every instruction in fromStep - called 'mpInstruction' [ | ~440 |
| if (pixels match for both Steps | |
| within the triggerRect of mpInstruction) AND | |
| (triggerRect for | ~450 |
| mpInstruction does not overlap existing triggerRect of toStep) | |
| add 'mpInstruction' to toStep | ~460 |
| [ | |
| } | |
| ] | |
| ] | |

What is claimed is:

1. A method to capture user activities, specifically mouse motion and clicks and to simultaneously capture the appearance of the computer screen into a plurality of screenshots as the screen's appearance changes over time such that screenshots are captured only when the appearance of the screen changes.

2. A method to automatically create Interactive User Interface Simulations using the data from the capture method of claim 1 by analyzing the captured information and automatically converting it into an interactive simulation composed of a series of screenshots with one or more instructions for each.

3. A method for displaying and updating the User Interface Simulation of claim 2 while monitoring user activities and making the User Interface Simulation behave and respond appropriately so that the User Interface Simulation looks and behaves like the real User Interface, as captured per claim 1, during presentation to an audience.
